(19) United States
(12) Patent Application Publication
(10) Pub. No.: US 2007/0279935 A1
(43) Pub. Date: Dec. 6, 2007

(54) FLEXIBLE LIGHT GUIDE

(75) Inventors: Mark E. Gardiner, Petaluma, CA (US); Gary T. Boyd, Woodbury, MN (US); L. Peter Erickson, Minneapolis, MN (US); Dale L. Ehnes, Cotati, CA (US); Jeffrey L. Solomon, Vadnais Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/421,241

(22) Filed: May 31, 2006

(51) Int. Cl. F21V 7/04

(52) U.S. Cl. 362/610

(57) ABSTRACT

A flexible light guide and a display system incorporating same are disclosed. The light guide includes a first flexible layer and a second flexible layer. Each flexible layer has a first major surface and a second major surface. The second major surface of the first flexible layer is in contact with the first major surface of the second flexible layer. The first major surface of the first flexible layer has a plurality of discrete light extractors capable of extracting light propagating in the light guide such that light is extracted uniformly over the entire first major surface of the first flexible layer.

### FIELD OF THE INVENTION

This invention generally relates to light guides and displays incorporating same. In particular, the invention relates to multilayer flexible light guides.

### BACKGROUND

Optical displays, such as liquid crystal displays (LCDs), are becoming increasingly commonplace, finding use for example in mobile telephones, portable computer devices ranging from hand held personal digital assistants (PDAs) to laptop computers, portable digital music players, LCD desktop computer monitors, and LCD televisions. In addition to becoming more prevalent, LCDs are becoming thinner as the manufacturers of electronic devices incorporating LCDs strive for smaller package sizes.

Many LCDs use a backlight for illuminating the LCD's display area. The backlight typically includes a light guide in the form of a slab or wedge often of an optically transparent polymeric material produced by, for example, injection molding. In many applications, the backlight includes one or more light sources that couple light into the light guide from one or more edges of the light guide. In a slab waveguide, the coupled light typically travels through the light guide by total internal reflection from the top and bottom surfaces of the light guide until encountering some feature that causes a portion of the light to exit the light guide. These features are often printed dots made of a light scattering material. The printed dots are commonly created by screen printing technologies.

### SUMMARY OF THE INVENTION

Generally, the present invention relates to light guides. The present invention also relates to displays incorporating light guides.

In one embodiment of the invention, a light guide includes a first flexible layer and a second flexible layer. Each flexible layer has a first major surface and a second major surface. The second major surface of the first flexible layer is in contact with the first major surface of the second flexible layer. The first major surface of the first flexible layer has a plurality of discrete light extractors capable of extracting light propagating in the light guide. Light is extracted uniformly over the first major surface of the first flexible layer.

In another embodiment of the invention, a flexible light guide includes a first flexible layer disposed on and in contact with an entire major surface of a second flexible layer. The first flexible layer has a plurality of discrete light extractors. Light propagating in the flexible layers by total internal reflection is extracted by the plurality of discrete light extractors. The intensity profile of the extracted light is uniform over the light guide.

In another embodiment of the invention, a light guide includes a first flexible layer that is attached to and covers a second flexible layer. A plurality of discrete light extractors are dispersed throughout a major surface of the first flexible layer. The light extractors are capable of extracting light that propagates in the light guide.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic side-view of a back light system;

FIG. 2A is a schematic top-view of a back light system having discrete light extractors;

FIG. 2B is a schematic three-dimensional view of a backlight system having an alignment tab for alignment with a plate;

FIG. 3 is a schematic top-view of a back light system having discrete light extractors;

FIG. 4 is a schematic side-view of a display system; and

FIG. 5 is a schematic side-view of another back light system.

### DETAILED DESCRIPTION

The present invention generally applies to back lights that incorporate a light guide for providing a desired illumination in a display system. The invention particularly applies to thin flexible light guides that can be easily and economically manufactured.

The present invention discloses a multilayer thin and flexible light guide for use in a backlight. The light guide can be fabricated using a continuous roll to roll process, such as a continuous cast and cure process. One advantage of the present invention is reduced display thickness. Another advantage of the present invention is reduced cost.

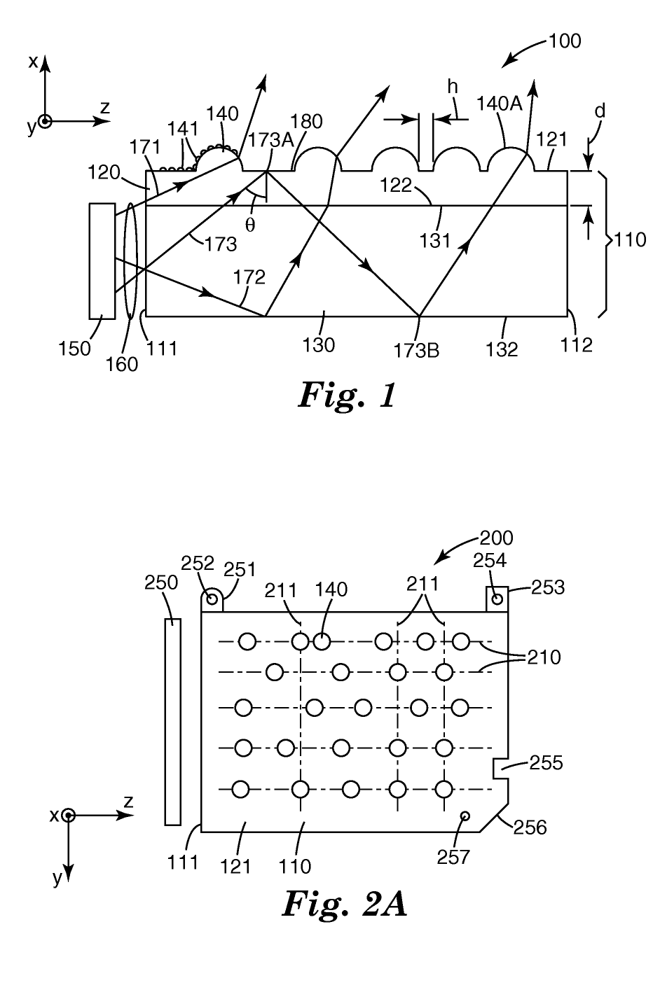

FIG. 1 is a schematic side-view of a backlight system 100. Backlight system 100 includes a light guide 110, a light source 150 placed proximate an edge 111 of light guide 110, and an optical coupler 160 for facilitating the coupling of light from light source 150 to light guide 110. In the exemplary embodiment shown in FIG. 1, optical coupler 160 is distinct from light guide 110. In some applications, optical coupler 160 may be an integral part of light guide 110, for example, by providing an appropriate curvature to edge 111 of light guide 110.

Light guide 110 includes a first flexible layer 120 having a first major surface 121 and a second major surface 122, and a second flexible layer 130 having a first major surface 131 and a second major surface 132. Second major surface 122 is in contact with first major surface 131. In some embodiments, substantially the entire second major surface 122 is in contact with substantially the entire first major surface 131.

Light from light source 150 propagates in light guide 110 in the general z-direction by reflection from major surfaces 121 and 132, where the reflections can primarily be total internal reflections if desired. For example, light ray 173 undergoes total internal reflection at major surface 121 at point 173A and at major surface 132 at point 173B.

First major surface 121 includes a plurality of discrete light extractors 140 that are capable of extracting light that propagates in the light guide 110. For example, light extractor 140 extracts at least a portion of light ray 171 that propagates in light guide 110 and is incident on light extractor 140. As another example, light extractor 140A extracts at least a fraction of light ray 173 that propagates in light guide 110 and is incident on light extractor 140A. In general, the spacing between neighboring light extractors can be different at different locations on major surface 121. Furthermore, the shape, respective heights, and/or the size of the light extractors can be different for different light extractors. Such variation can be useful in controlling the amount of light extracted at different locations on major surface 121.

If desired, light extractors 140 can be designed and arranged along first major surface 121 such that light is extracted uniformly over substantially the entire first major surface 121.

Furthermore, neighboring light extractors can be separated by substantially flat land area 180 having an average thickness “d.” In some embodiments, the average thickness of land area 180 is no greater than 20, or 15, or 10, or 5, or 2 microns.

In the exemplary embodiment shown in FIG. 1, light extractors 140 form a plurality of discrete light extractors. In some applications, light extractors 140 may form a continuous profile, such as a sinusoidal profile, that may extend, for example, along the y- and z-axes.

Light extractors 140 and/or land area 180 may have light diffusive features 141 for scattering a fraction, for example, a small fraction, of light that may be incident on the diffusive features while propagating inside light guide 110. Diffusive features 141 can assist with extracting light from the light guide. Furthermore, diffusive features 141 can improve uniformity of the intensity of light that propagates inside light guide 110 by, for example, scattering the light laterally along the y-axis.

Diffusive features 141 can be a light diffusive layer disposed, for example by coating, on surface 121. As another example, diffusive features 141 can be formed while making light extractors 140 by any suitable process, such as microreplication, embossing, or any other method that can be used to simultaneously or sequentially form light extractors 140 and diffusive features 141.

At least one of flexible layers 120 and 130 may be a bulk diffuser by, for example, including small particles of a guest material dispersed in a host material where the guest and host materials have different indices of refraction.

First flexible layer 120 has a first index of refraction n₁ and second flexible layer 130 has a second index of refraction n₂ where n₁ and n₂ can, for example, be indices of refraction in the visible range of the electromagnetic spectrum. In one embodiment of the invention, n₁ is greater than or equal to n₂. In some applications, n₁ is greater than or equal to n₂ for both S-polarized and P-polarized incident light.

In some embodiments, at least one of first flexible layer 120 and second flexible layer 130 is isotropic in refractive index. In some applications, both layers are isotropic.

Light source 150 may be any suitable type of light source such as a fluorescent lamp or a light emitting diode (LED). Furthermore, light source 150 may include a plurality of discrete light sources such as a plurality of discrete LEDs.

In the exemplary embodiment shown in FIG. 1, light source 150 is positioned proximate one edge of light guide 110. In general, one or more light sources may be positioned proximate one or more edges of light guide 110. For example, in FIG. 1, an additional light source may be placed near edge 112 of light guide 110.

Flexible layers 120 and 130 are preferably formed of substantially optically transparent material. Exemplary materials include glass or polymeric materials such as cyclic olefin co-polymers (COC), polyester (e.g., polyethylene naphthalate (PEN), polyethylene terephthalate (PET), and the like), polyacrylate, polymethylmethacrylate (PMMA), polycarbonate (PC), or any other suitable polymeric material.

In some embodiments, first flexible layer 120 and/or second flexible layer 130 are thin enough to be capable of bending without damage to a radius of curvature down to about 100, or 50, or 30, or 15, or 10, or 5 mm.

In some embodiments, the average thickness of the second flexible layer is at least 5, or 10, or 20, or 40 times the maximum thickness of the first flexible layer.

In some embodiments, the average thickness of the second flexible layer is no greater than 1000, or 700, or 500, or 400, or 250, or 200 microns.

In some embodiments, the maximum thickness of the first flexible layer is no greater than 100, or 50, or 15 microns.

In some embodiments, second flexible layer 130 is self-supporting while first flexible layer 120 is not. Here, “self-supporting” refers to a film that can sustain and support its own weight without breaking, tearing, or otherwise being damaged in a manner that would make it unsuitable for its intended use.

Second flexible layer 130 may be in the form of a uniformly thick slab, as shown schematically in FIG. 1, in which case, first and second major surfaces 131 and 132 are substantially parallel. In some applications, however, second flexible layer may be in the form of a wedge or other layer of non-uniform thickness.

The exemplary embodiment of FIG. 1 shows convex lenslets as light extractors 140, meaning that each lenslet forms a bump on surface 121. In general, light extractors 140 can have any shape that can result in a desired light extraction. For example, light extractors 140 can include concave structures forming depressions in surface 121, convex structures such as hemispherical convex lenslets, prismatic structures, sinusoidal structures, or any other shape with linear or nonlinear facets or sides that may be suitable in providing, for example, a desired light extraction pattern.

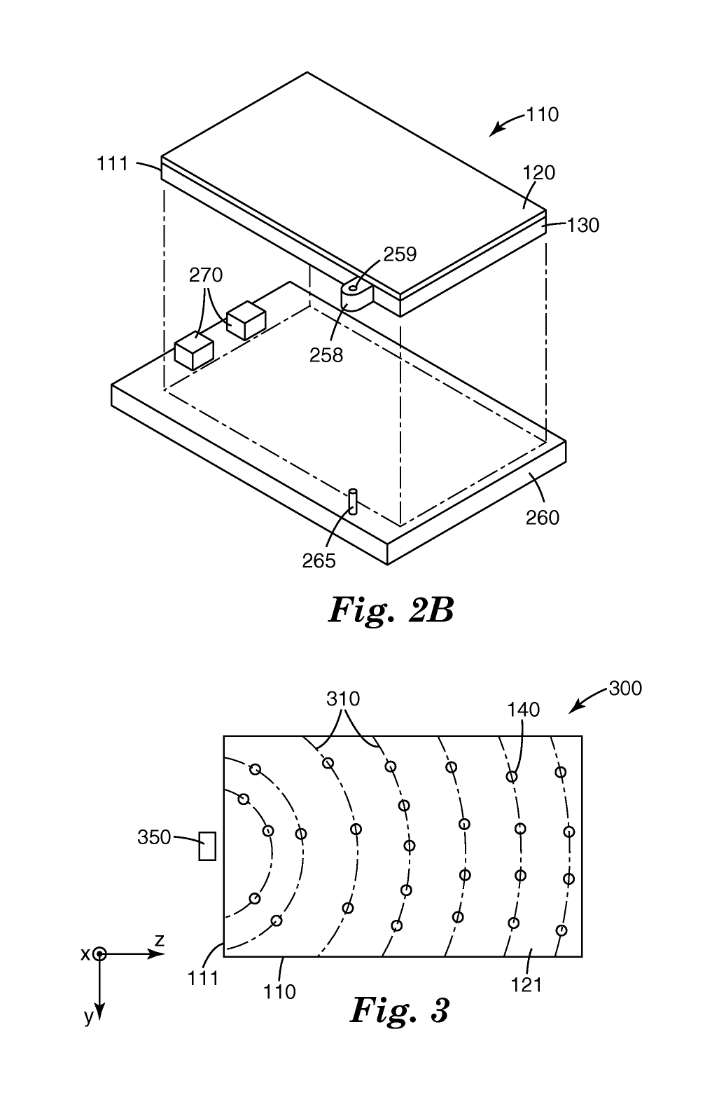

The distribution and density of light extractors 140 can be chosen to provide a desired light extraction and may depend on a number of factors such as the shape of light source 150. For example, FIG. 2A shows a backlight system 200 that includes an extended light source 250, such as a line-light source, placed proximate an entire edge 111 of light guide 110. In this example, the plurality of discrete light extractors 140 are arranged along a plurality of mutually parallel lines, such as parallel lines 210 and parallel lines 211 where each line includes at least two discrete light extractors.

In general, density, shape, and size of light extractors 140 can be different at different locations along surface 121 to provide a desired light distribution for the extracted light.

Light guide 110 may have alignment features for aligning the light guide to other components in a system that incorporates the light guide. For example, light guide 110 may have at least one alignment tab and/or alignment notch and/or alignment hole for aligning light guide 110 to other layers in a system. For example, light guide 110 in FIG. 2A has a round alignment tab 251 with a corresponding through-hole 252, a square alignment tab 253 with a corresponding through-hole 254, a side or edge notch 255 cut into light guide 110 along an edge of the light guide, and a corner notch 256 at a corner of the light guide and an alignment hole 257 positioned at an interior location of the light guide.

FIG. 2B shows a schematic three-dimensional view of light guide 110 having an alignment tab 258 with a corresponding hole 259, where the tab is used to align light guide 110 to, for example, a plate 260 that includes a post 265 capable of fitting into hole 259. Plate 260 further includes light sources 270 for providing light to light guide 110. Inserting post 265 into hole 259 can assist in aligning light sources 270 with edge 111 of light guide 110.

In general, it is desirable to arrange the alignment features in light guide 110 in such a way, for example, asymmetrically, so that there is a unique match between the alignment features and their corresponding features in plate 260. Such an arrangement will reduce or eliminate the possibility of, for example, positioning the light guide with the wrong side of the light guide facing plate 260.

As another example, FIG. 3 shows a backlight system 300 that includes an essentially point light source 350, such as an LED. In this example, the plurality of discrete light extractors 140 are arranged along concentric arcs, such as arcs 310, centered on the light source, where each arc includes at least two discrete light extractors.

The density of light extractors 140 can vary across first major surface 121. For example, the density can increase with distance along the z-axis. Such an arrangement can, for example, result in light extracted from light guide 110 having uniform irradiance across first major surface 121.

FIG. 1 shows discrete light extractors 140 where adjacent light extractors are separated by flat land area 180. In some applications, light extractors 140 may form a continuous pattern across a portion of the entire first major surface 121. In some cases, light extractors 140 may form a continuous pattern across the entire first major surface 121. For example, light extractors 140 may form a sinusoidal pattern across surface 121.

Lightguide 110 can be manufactured using any suitable manufacturing method, such as UV cast and cure, extrusion such as extrusion casting, co-extrusion, or other known methods. As an example, light guide 110 can be manufactured by co-extruding flexible layers 120 and 130, followed by a compression molding step during which extractors 140 are formed in surface 121.

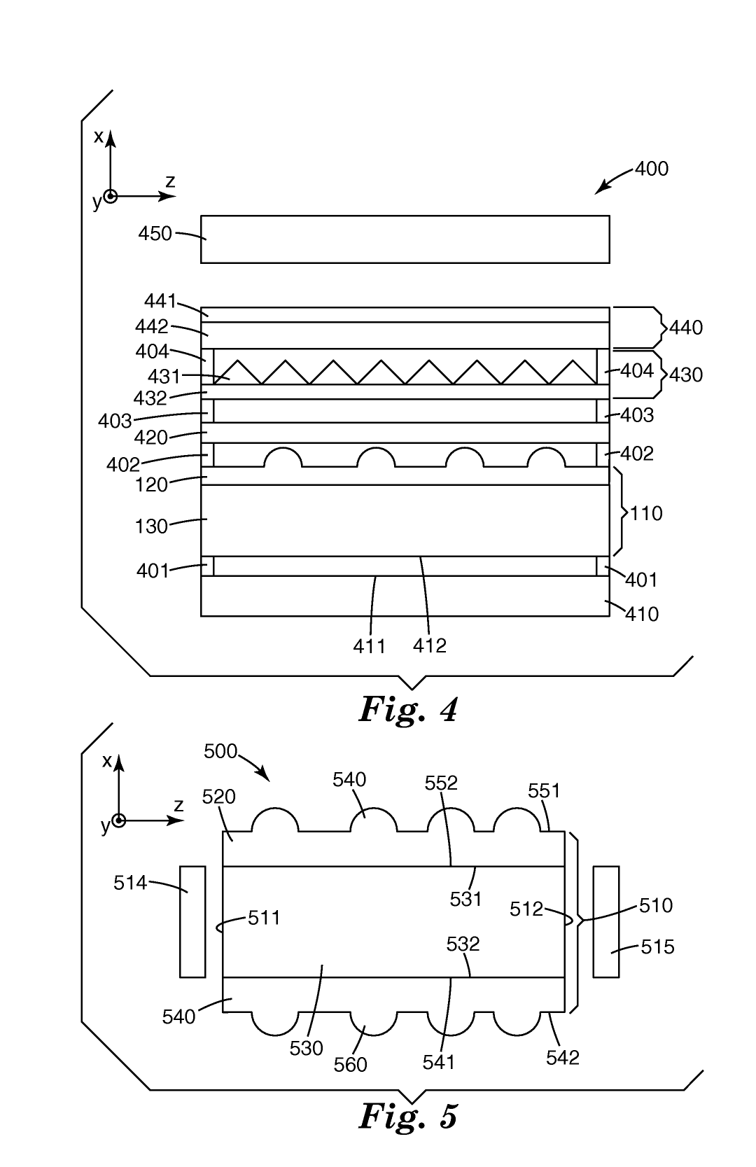

FIG. 4 shows a schematic side-view of a display system 400 in accordance with one embodiment of the invention. Display system 400 includes light guide 110, a diffuser 420, a first light redirecting layer 430, a second light redirecting layer 440, and a display panel 450 such as a liquid crystal panel. Display system 400 further includes a reflector 410 attached to light guide 110 by adhesive 401. Diffuser 420 is attached to light guide 110 and first light redirecting layer 430 with adhesives 402 and 403, respectively. Furthermore, first and second light redirecting layers 430 and 440 are attached by adhesive 404.

FIG. 4 shows adhesives 401-404 placed along opposite edges of display system 400. In general, each adhesive can be placed at one or multiple locations to provide adequate attachment between adjacent layers. For example, an adhesive may be placed along all edges of neighboring layers. In some applications, an adhesive may be placed at discrete locations along the periphery of adjacent layers. In some other applications, an adhesive may cover entire surfaces of adjacent layers. For example, adhesive 401 may cover substantially the entire surfaces 411 and 412 of reflector 410 and light guide 110, respectively.

Light redirecting layer 430 includes a microstructured layer 431 disposed on a substrate 432. Similarly, light redirecting layer 440 includes a microstructured layer 441 disposed on a substrate 442. Light redirecting layers 430 and 440 can be conventional prismatic light directing layers previously disclosed, for example, in U.S. Pat. Nos. 4,906,070 (Cobb) and 5,056,892 (Cobb). For example, microstructured layer 431 can include linear prisms extended linearly along the y-axis and microstructured layer 441 can include linear prisms extended linearly along the z-axis.

The operation of a conventional light redirecting layer has been previously described, for example, in U.S. Pat. No. 5,056,892 (Cobb). In summary, light rays that strike the structures in microstructured layers 431 and 441 at incident angles larger than the critical angle are totally internally reflected back and recycled by reflector 410. On the other hand, light rays which are incident on the structures at angles less than the critical angle are partly transmitted and partly reflected. An end result is that light redirecting layers 430 and 440 can result in display brightness enhancement by recycling light that is totally internally reflected.

The exemplary embodiment shown in FIG. 4 includes a number of adhesive layers such as adhesive layers 402 and 403. In some applications, one or more of the adhesive layers in display system 400 may be eliminated. For example, in some applications adhesive layers 402, 403, and 404 may be eliminated in which case the remaining layers may be aligned with respect to each other by other means such as by aligning the edges of the layers or by including alignment tabs.

FIG. 5 is a schematic side-view of a backlight system 500. Backlight system 500 includes a light guide 510, a light source 514 placed proximate an edge 511 of light guide 510, and a light source 515 placed proximate a different edge 512 of the light guide.

Light guide 510 includes a first flexible layer 520 having a first major surface 551 and a second major surface 552, a second flexible layer 530 having a first major surface 531 and a second major surface 532, and a third flexible layer 540 having a first major surface 541 and a second major surface 542. Second major surface 552 is in contact with first major surface 531, and first major surface 541 is in contact with second major surface 532. In some cases, substantially the entire second major surface 552 is in contact with substantially the entire first major surface 531. In some cases, substantially the entire first major surface 541 is in contact with substantially the entire second major surface 532.

First major surface 551 includes a plurality of discrete light extractors 540, similar to light extractors 140 of FIG. 1, that are capable of extracting light that propagates in light guide 510. Furthermore, second major surface 542 includes a plurality of discrete light extractors 560, similar to light extractors 140 of FIG. 1, that are capable of extracting light that propagates in the light guide 510. In exemplary embodiments, the entire light guide 510 is flexible.

In some cases, at least one of first flexible layer 520, second flexible layer 530, and third flexible layer 540, is isotropic in refractive index. In some cases, all three layers are isotropic.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A light guide comprising a first flexible layer and a second flexible layer, each layer having a first major surface and a second major surface, the second major surface of the first flexible layer being in contact with the first major surface of the second flexible layer, the first major surface of the first flexible layer having a plurality of discrete light extractors capable of extracting light propagating in the light guide such that light is extracted uniformly over substantially the entire first major surface of the first flexible layer.

2. The light guide of claim 1, wherein an average thickness of the second flexible layer is at least 10 times the maximum thickness of the first flexible layer.

3. The light guide of claim 1, wherein an average thickness of the second flexible layer is at least 20 times the maximum thickness of the first flexible layer.

4. The light guide of claim 1, wherein an average thickness of the second flexible layer is at least 40 times the maximum thickness of the first flexible layer.

5. The light guide of claim 1, wherein an average thickness of the second flexible layer is no greater than 700 microns.

6. The light guide of claim 1, wherein an average thickness of the second flexible layer is no greater than 400 microns.

7. The light guide of claim 1, wherein an average thickness of the second flexible layer is no greater than 250 microns.

8. The light guide of claim 1, wherein an average thickness of the first flexible layer is no greater than 50 microns.

9. The light guide of claim 1, wherein an average thickness of the first flexible layer is no greater than 20 microns.

10. The light guide of claim 1, wherein an average thickness of the first flexible layer is no greater than 15 microns.

11. The light guide of claim 1, wherein the first flexible layer has a substantially flat land area separating the plurality of discrete light extractors, the average thickness of the land area being no greater than 10 microns.

12. The light guide of claim 11, wherein the average thickness of the land area is no greater than 5 microns.

13. The light guide of claim 1, wherein at least one of the first and second flexible layers is capable of being bent without damage to a radius of curvature down to about 15 mm.

14. The light guide of claim 1, wherein at least one of the first and second flexible layers is capable of being bent without damage to a radius of curvature down to about 5 mm.

15. The light guide of claim 1, wherein the first and second major surfaces of the second flexible layer are substantially parallel.

16. The light guide of claim 1, wherein at least some of the plurality of discrete light extractors comprise concave structures.

17. The light guide of claim 1, wherein at least some of the plurality of discrete light extractors comprise convex structures.

18. The light guide of claim 1, wherein each of the plurality of discrete light extractors is substantially a hemispherical convex lenslet.

19. The light guide of claim 1 further comprising a light source placed proximate an edge of the second flexible layer.

20. The light guide of claim 19, wherein the plurality of discrete light extractors are arranged along concentric arcs centered on the light source, each arc including at least two discrete light extractors.

21. The light guide of claim 1, wherein the plurality of discrete light extractors are arranged along mutually parallel lines, each line including at least two discrete light extractors.

22. The light guide of claim 1, wherein substantially the entire second major surface of the first flexible layer is in contact with substantially the entire first major surface of the second flexible layer.

23. The light guide of claim 1, wherein the second flexible layer comprises a UV cured polymer.

24. The light guide of claim 1 being flexible.

25. The light guide of claim 1 further comprising at least one alignment tab or notch.

26. The light guide of claim 1, wherein at least one of the first and second flexible layers is a bulk diffuser.

27. The light guide of claim 1, wherein the first and second flexible layers are isotropic.

28. The light guide of claim 1 further comprising a third flexible layer having a first major surface and a second major surface, the first major surface of the third flexible layer being in contact with the second major surface of the second flexible layer, the second major surface of the third flexible layer having a plurality of discrete light extractors capable of extracting light propagating in the light guide.

29. The light guide of claim 29, wherein the third flexible layer is isotropic.

30. A flexible light guide comprising a first flexible layer disposed on and in contact with substantially an entire major surface of a second flexible layer, the first flexible layer having a plurality of discrete light extractors, wherein light propagating in the flexible layers by total internal reflection is extracted by the plurality of discrete light extractors, the intensity profile of the extracted light being uniform over substantially the entire light guide.

31. A light guide comprising a first flexible layer attached to and covering a second flexible layer, a plurality of discrete light extractors being dispersed throughout a major surface of the first flexible layer, the light extractors being capable of extracting light propagating in the light guide.

32. The light guide of claim 32 being flexible.
